(19) United States
(12) Patent Application Publication
(10) Pub. No.: US 2026/0244719 A1
(43) Pub. Date: Aug. 20, 2026

(54) INFORMATION PROCESSING METHOD, INFORMATION PROCESSING SYSTEM, AND RECORDING MEDIUM

(71) Applicant: Panasonic Intellectual Property Management Co., Ltd., Osaka (JP)

(72) Inventors: Takeru KOIE, Saitama (JP); Hideki MATSUSHIMA, Tokyo (JP); Yuji UNAGAMI, Osaka (JP)

(21) Appl. No.: 19/549,232

(22) Filed: Feb. 25, 2026

Related U.S. Application Data
(63) Continuation of application No. PCT/JP2024/024679, filed on Apr. 9, 2024.
(60) Provisional application No. 63/538,537, filed on Sep. 15, 2023.

(51) Int. Cl. G06F 21/16; G06N 3/08; G06Q 20/38

(52) U.S. Cl. CPC G06F 21/16; G06N 3/08; G06Q 20/389

(57) ABSTRACT

An information processing method includes: obtaining first content; determining whether the first content contains first legitimacy information as a digital watermark, the first legitimacy information indicating that the first content obtained is legitimate as content to be inputted to a trained model; when the first content is determined to contain the first legitimacy information, inputting the first content to the trained model to obtain second content generated by the trained model; and outputting the second content obtained.

### CROSS REFERENCE TO RELATED APPLICATIONS

This is a continuation application of PCT International Application No. PCT/JP2024/024679 filed on Jul. 9, 2024, designating the United States of America, which is based on and claims priority of U.S. Provisional Patent Application No. 63/538537 filed on Sep. 15, 2023. The entire disclosures of the above-identified applications, including the specifications, drawings and claims are incorporated herein by reference in their entirety.

### FIELD

The present disclosure relates to an information processing method, an information processing system, and a recording medium.

### BACKGROUND

Machine learning models, often called artificial intelligence (AI) models, can receive input of various sorts of information to generate and output content having features based on the input information.

For example, a server device generates an illustration background image in response to a prompt inputted to an AI image generator trained with a machine learning model called a diffusion model (see Patent Literature (PTL) 1).

### CITATION LIST

### Patent Literature

PTL 1: Japanese Patent No. 7398723

### SUMMARY

### Technical Problem

A machine learning model that receives input of an enormous number of information items generates and outputs information based on each of the input information items. Accordingly, an information processing system operating the machine learning model may consume an enormous amount of power.

In view of the above, the present disclosure provides an information processing method and the like that contribute to reducing the power consumption of an information processing system operating a machine learning model.

### Solution to Problem

An information processing method according to an aspect of the present disclosure is an information processing method including: obtaining first content; determining whether the first content contains first legitimacy information as a digital watermark, the first legitimacy information indicating that the first content obtained is legitimate as content to be inputted to a trained model; when the first content is determined to contain the first legitimacy information, inputting the first content to the trained model to obtain second content generated by the trained model; and outputting the second content obtained.

It should be noted that these general or specific aspects may be implemented using a system, a device, an integrated circuit, a computer program, or a computer-readable recording medium such as a compact disc read-only memory (CD-ROM), or any combination of systems, devices, integrated circuits, computer programs, and recording media.

### Advantageous Effects

The present disclosure contributes to reducing the power consumption of an information processing system operating a machine learning model.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating the overall configuration of an information processing system in an embodiment.

FIG. 2 is a block diagram illustrating the functional configuration of a ledger server in an embodiment.

FIG. 3 is a block diagram illustrating the functional configuration of a control system in an embodiment.

FIG. 4 is a block diagram illustrating the functional configuration of a generation system in an embodiment.

FIG. 5 is a block diagram illustrating the functional configuration of a training system in an embodiment.

FIG. 6 is a sequential diagram illustrating an addition process for adding legitimacy information to content in an embodiment.

FIG. 7 is an explanatory diagram illustrating a first example of NFT metadata in an embodiment.

FIG. 8 is a flowchart illustrating a training process for a machine learning model in an embodiment.

FIG. 9A is an explanatory diagram illustrating a first example of training content in an embodiment.

FIG. 9B is an explanatory diagram illustrating a second example of training content in an embodiment.

FIG. 10 is a sequential diagram illustrating a generation process for generating content in an embodiment.

FIG. 11 is an explanatory diagram illustrating an example of source content in an embodiment.

FIG. 12 is an explanatory diagram illustrating an example of generated content in an embodiment.

FIG. 13 is an explanatory diagram illustrating correspondence information in an embodiment.

FIG. 14 is an explanatory diagram illustrating a second example of NFT metadata in an embodiment.

FIG. 15 is a sequential diagram illustrating a purchase process for generated content in an embodiment.

FIG. 16 is an explanatory diagram illustrating an example of purchase transaction data in an embodiment.

FIG. 17 is an explanatory diagram illustrating a first example of transfer transaction data in an embodiment.

FIG. 18 is an explanatory diagram illustrating a second example of transfer transaction data in an embodiment.

FIG. 19 is a sequential diagram illustrating a variation of a purchase process for generated content in an embodiment.

FIG. 20 is an explanatory diagram illustrating a third example of transfer transaction data in an embodiment.

FIG. 21 is an explanatory diagram illustrating a data structure of a blockchain, which is an example of a distributed ledger.

FIG. 22 is an explanatory diagram illustrating a data structure of transaction data.

FIG. 23 is an explanatory diagram illustrating transaction data pertaining to execution of a smart contract.

FIG. 24 is an explanatory diagram illustrating processing pertaining to execution of a smart contract.

FIG. 25 is an explanatory diagram illustrating structures of an NFT and metadata.

### DESCRIPTION OF EMBODIMENT

### Underlying Knowledge Forming Basis of the Present Disclosure

Regarding information generation techniques involving machine learning models described in the “Background” section, the present inventors have found the following:

Machine learning models can receive input of various sorts of information to generate and output content having features based on the input information.

A machine learning model that receives input of an enormous number of information items generates and outputs information based on each of the input information items. Accordingly, an information processing system operating the machine learning model may consume an enormous amount of power due to a significantly heavy processing load on the system. In addition, storing the generated information may require a massive storage capacity.

Furthermore, if digital content (also referred to simply as content) is to be used as input information to the machine learning model, content illegitimate as an input to the machine learning model (also referred to simply as illegitimate content) may be inputted to the machine learning model. It should be noted that content may include image content (including still image content and video content), audio content, and text content; a single content item may contain two or more types of content (e.g., image content and audio content).

For example, content may be inputted to the machine learning model by someone who is not the owner or creator (also referred to as the owner, etc.) of the content without the permission of the owner, etc.

It should be noted that the expression “content is inputted to a machine learning model” encompasses cases in which the content is inputted to the machine learning model as training data for the machine learning model, and cases in which the content is inputted to the machine learning model as input data for content generation by the machine learning model.

Inputting illegitimate content to the machine learning model as training data for the machine learning model may lead the machine learning model to generate content having the characteristics of the illegitimate content. Similarly, inputting illegitimate content to the machine learning model as input data for content generation may cause the machine learning model to generate content based on the illegitimate content.

If content generated by the machine learning model from illegitimate content inputted to the machine learning model is allowed to be used freely, the legitimate rights of the owner, etc., of the content inputted to the machine learning model may be infringed. Then, the power consumed for training the machine learning model using the illegitimate content, or consumed for image generation based on the illegitimate content, may be regarded as wasted in the end.

In view of the above, the present disclosure provides an information processing method and the like that contribute to reducing the power consumption of an information processing system operating a machine learning model.

The present disclosure may also contribute to reducing the processing load on the information processing system operating the machine learning model, or reducing the required storage capacity.

The following illustrates aspects according to the disclosure in this specification and describes advantageous effects achieved by the aspects.
(1) An information processing method including: obtaining first content; determining whether the first content contains first legitimacy information as a digital watermark, the first legitimacy information indicating that the first content obtained is legitimate as content to be inputted to a trained model; when the first content is determined to contain the first legitimacy information, inputting the first content to the trained model to obtain second content generated by the trained model; and outputting the second content obtained.

According to the above aspect, the legitimacy of the first content is determined based on a digital watermark. The first content determined to be legitimate can be inputted to the trained model, resulting in the output of the second content generated by the trained model. The trained model may therefore be prevented from outputting second content generated based on illegitimate content inputted to the trained model, in contrast to cases in which the above legitimacy determination is not performed. This may reduce the power consumption of an information processing system operating a machine learning model. Thus, the information processing method may contribute to reducing the power consumption of the information processing system operating the machine learning model.
(2) The information processing method according to (1), further including: when the second content is obtained, causing second legitimacy information to be added as a digital watermark to the second content, in which the second legitimacy information is information indicating that the second content is legitimate content outputted by the trained model, and in the outputting of the second content, the second content to which the second legitimacy information is added is outputted.

According to the above aspect, legitimacy information is added as a digital watermark to content generated by the trained model. The legitimacy information added as a digital watermark may therefore prove the legitimacy of the second content outputted. This may prevent illegitimate content from being used as content outputted from the information processing system, thereby allowing legitimate content to be appropriately used as content outputted from the information processing system. Thus, the information processing method may more appropriately contribute to reducing the power consumption of the information processing system operating the machine learning model.
(3) The information processing method according to (1) or (2), in which a first non-fungible token (NFT) that corresponds one-to-one to the first content is stored in a distributed ledger, the first NFT being associated with an owner of the first content as an owner of the first NFT, the information processing method further including: when the second content is obtained, storing, in the distributed ledger, a second NFT that corresponds one-to-one to the second content and is associated with an operator of an information processing system that executes the information processing method, the operator serving as an owner of the second NFT.

According to the above aspect, the distributed ledger stores NFTs that correspond one-to-one to content items (i.e., content items including the first content and the second content), and the owners of the content items are associated with the corresponding NFTs as the owners of the NFTs. This may enable content owner information to be managed appropriately while kept substantially untampered with. Thus, the information processing method may more appropriately contribute to reducing the power consumption of the information processing system operating the machine learning model.
(4) The information processing method according to (3), further including: storing, in the distributed ledger, purchase transaction data indicating that a user is to purchase the second content and further indicating an amount of value information equivalent to a price for purchasing the second content; storing, in the distributed ledger, first transfer transaction data indicating that a first portion of the value information is to be transferred from the user to the owner of the first content; and storing, in the distributed ledger, second transfer transaction data indicating that a second portion of the value information excluding the first portion is to be transferred from the user to the operator.

According to the above aspect, when the user purchases the second content, the price for the second content can be split between the owner of the first content and the operator of the information processing system, and transferred to the owner and the operator. This is done for the following reason. The second content generated by the trained model can be considered a result of both the contribution of the first content used as input data for generating the second content and the contribution of the information processing system offering the model. It is therefore appropriate to split the price between the provider of the first content and the operator of the information processing system offering the model. Thus, the information processing method may more appropriately contribute to reducing the power consumption of the information processing system operating the machine learning model.
(5) The information processing method according to (4), in which the first portion accounts for a greater portion of the value information as a contribution of the first content to generation of the second content is greater, and the second portion is a portion obtained by subtracting the first portion from an entirety of the value information.

According to the above aspect, a greater amount of value information is transferred to the provider of the first content that has made a greater contribution to the generation of the second content. This enables appropriate transferring, to the provider of the first content, an amount of value information corresponding to the contribution to the generation of the second content. Thus, the information processing method may more appropriately contribute to reducing the power consumption of the information processing system operating the machine learning model.
(6) The information processing method according to (5), in which the contribution of the first content to the generation of the second content is greater as a degree of similarity between the second content and the first content is greater.

According to the above aspect, the contribution of the first content to the generation of the second content can readily be calculated based on the degree of similarity between the first content and the second content. Thus, the information processing method may more readily and more appropriately contribute to reducing the power consumption of the information processing system operating the machine learning model.
(7) The information processing method according to any one of (1) to (6), further including: when the first content is determined not to contain the first legitimacy information, prohibiting the outputting of the second content generated by the trained model.

According to the above aspect, the legitimacy of the first content is determined based on a digital watermark. The trained model is then prohibited from outputting second content generated based on illegitimate content inputted to the trained model. This may further reduce the power consumption of the information processing system operating the machine learning model. Thus, the information processing method may contribute to further reducing the power consumption of the information processing system operating the machine learning model.
(8) The information processing method according to any one of (1) to (7), in which the trained model is a machine learning model that has been trained using third content to generate and output fifth content based on fourth content inputted to the machine learning model, the third content being content that contains third legitimacy information as a digital watermark, the third legitimacy information indicating that the third content is legitimate as content to be inputted to the trained model, and the fifth content is content obtained by adding, to the fourth content, a feature related to the training that the machine learning model has undergone.

According to the above aspect, the trained model trained using the legitimate third content can receive input of the legitimate first content to generate and output the second content. This may prevent the use of a trained model trained using illegitimate content, and also prevent the trained model from outputting content generated based on illegitimate content. Thus, the information processing method may more appropriately contribute to reducing the power consumption of the information processing system operating the machine learning model.
(9) The information processing method according to (1), in which the trained model is a neural network model.

According to the above aspect, using a neural network model as the trained model may more readily contribute to reducing the power consumption of the information processing system operating the machine learning model.
(10) An information processing method including: obtaining third content; determining whether the third content contains third legitimacy information as a digital watermark, the third legitimacy information indicating that the third content obtained is legitimate as content to be inputted to a machine learning model; and when the third content is determined to contain the third legitimacy information, training the machine learning model to generate and output fifth content based on fourth content inputted to the machine learning model, in which the fifth content is content obtained by adding, to the fourth content, a feature that is based on the training that the machine learning model has undergone.

According to the above aspect, the machine learning model can be trained using the legitimate third content to construct a trained model, which outputs the fifth content resultant from adding, to the fourth content, a feature based on the training. Thus, the information processing method may contribute to reducing the power consumption of the information processing system operating the machine learning model.
(11) An information processing system including: an obtainer that obtains first content; a determiner that determines whether the first content contains first legitimacy information as a digital watermark, the first legitimacy information indicating that the first content obtained is legitimate as content to be inputted to a trained model; a controller that, when the first content is determined to contain the first legitimacy information, inputs the first content to the trained model to obtain second content generated by the trained model; and an outputter that outputs the second content obtained.

According to the above aspect, advantageous effects similar to those of the above corresponding information processing method are achieved.
(12) An information processing system including: an obtainer that obtains third content; a determiner that determines whether the third content contains third legitimacy information as a digital watermark, the third legitimacy information indicating that the third content obtained is legitimate as content to be inputted to a machine learning model; and a trainer that, when the third content is determined to contain the third legitimacy information, trains the machine learning model to generate and output fifth content based on fourth content inputted to the machine learning model, in which the fifth content is content obtained by adding, to the fourth content, a feature that is based on the training that the machine learning model has undergone.

According to the above aspect, the same advantageous effects as those produced by the information processing method are produced.
(13) A program for causing a computer to execute the information processing method according to (1).

According to the above aspect, the same advantageous effects as those produced by the information processing method are produced.
(14) A program for causing a computer to execute the information processing method according to (10).

According to the above aspect, the same advantageous effects as those produced by the information processing method are produced.

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Hereinafter, an exemplary embodiment will be specifically described with reference to the accompanying Drawings.

It should be noted that the exemplary embodiment described below shows a general or specific example. The numerical values, shapes, materials, constituent elements, the arrangement and connection of the constituent elements, steps, the processing order of the steps etc. shown in the following exemplary embodiment are mere examples, and therefore do not limit the scope of the present disclosure. Furthermore, among the constituent elements in the following exemplary embodiment, those not recited in any one of the independent claims representing the most generic concepts will be described as optional elements.

### Embodiment

This embodiment will describe an information processing method and an information processing system that contribute to reducing the power consumption of the information processing system operating a machine learning model.

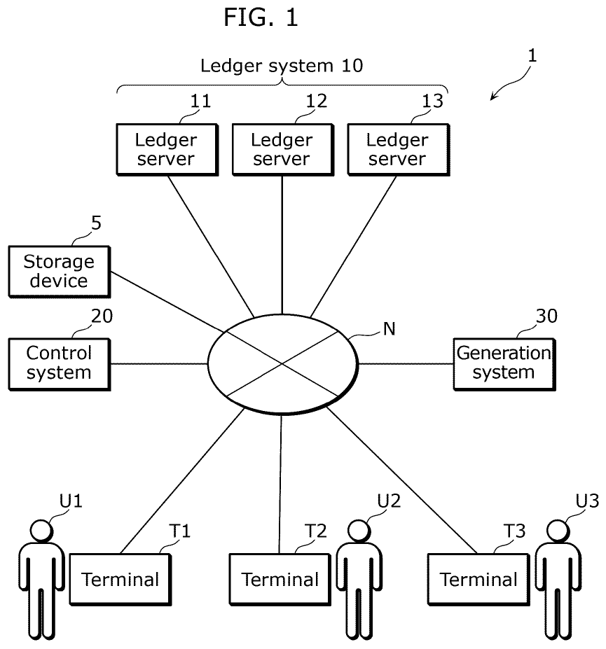

FIG. 1 is a schematic diagram illustrating the overall configuration of information processing system 1 in this embodiment. Information processing system 1 is an example of an information processing system that contributes to reducing the power consumption of the information processing system operating a machine learning model.

Information processing system 1 performs control so that content legitimate as an input to a machine learning model (also referred to simply as legitimate content) is inputted to the machine learning model, and content illegitimate as an input to the machine learning model (also referred to simply as illegitimate content) is not inputted to the machine learning model. It should be noted that the expression “content is inputted to a machine learning model” encompasses cases in which the content is inputted to the machine learning model as training data for the machine learning model, and cases in which the content is inputted to the machine learning model as input data for content generation by the machine learning model.

As shown in FIG. 1, information processing system 1 includes ledger system 10, control system 20, and generation system 30. Information processing system 1 may be connected to storage device 5 and terminals T1, T2, and T3. Alternatively, information processing system 1 may further include storage device 5 or terminal T1, T2, or T3. The above systems and devices are connected to network N, through which they can communicate with each other.

Ledger system 10 is an information processing system that maintains information using a distributed ledger. The distributed ledger of ledger system 10 stores information on non-fungible tokens (NFTs) corresponding one-to-one to legitimate content items (specifically, the information includes NFT generation and transfer history). The NFTs in the distributed ledger allow tracing the generation and transfer of their corresponding legitimate content items (in other words, the occurrences and changes of ownership).

Ledger system 10 can use the distributed ledger to perform processing based on smart contracts. Through processing based on smart contracts, ledger system 10 can generate and transfer NFTs.

Ledger system 10 includes ledger servers 11, 12, and 13 (also referred to as ledger servers 11, etc.), which are a group of servers holding the distributed ledger. When at least one of ledger servers 11, etc., receives transaction data, the transaction data is stored in the distributed ledger and shared by all ledger servers 11, etc. The number of ledger servers in the server group is not limited to three and may be two, or more than three.

Ledger server 11 is a computer that holds and manages the distributed ledger. While maintaining the distributed ledger, ledger server 11 updates the distributed ledger in synchronization with other ledger servers (specifically, ledger servers 12 and 13).

Each of ledger servers 12 and 13 is similar to ledger server 11 and operates independently of ledger server 11.

Storage device 5 stores data. Storage device 5 can be accessed (specifically, read from or written to) by ledger system 10 or terminal T1, T2, or T3 through network N. More than one storage device 5 may be used. Storage device 5 can store various sorts of information, including content and metadata.

Control system 20 is an information processing system that manages or controls content inputted to a machine learning model. Control system 20 adds legitimacy information as a digital watermark to legitimate content. Control system 20 also performs control for storing, in ledger system 10, an NFT corresponding one-to-one to the legitimate content. Details of specific processing by control system 20 will be described below. Control system 20 may be implemented by a single device or by multiple devices interconnected through network N.

Generation system 30 is an information processing system that generates content using a machine learning model. Having a trained machine learning model (also referred to as a trained model), generation system 30 inputs legitimate content to the trained model to generate new content. When generated content is purchased, generation system 30 can split tokens, paid as the price for the purchase, between the content provider and the operator of generation system 30. Details of specific processing by generation system 30 will be described below. Generation system 30 may be implemented by a single device or by multiple devices interconnected through network N.

Terminal T1 is an information processing device used by user U1 who owns content (also referred to as training content) for use in training the machine learning model of generation system 30. Terminal T1, which includes at least a processor, a memory, a user interface, and a communication interface, can use the user interface or the communication interface to receive input of information, generate information, display information, output information as sound, or transmit and receive information. Terminal T1 may be, for example, a personal computer, a tablet, or a smartphone. Terminal T1 holds, in its memory, training data (specifically, training content) for model 304 and can provide the training data to entities such as control system 20. Details of specific processing by terminal T1 will be described below.

Terminal T2 is an information processing device used by user U2 who owns content (also referred to as source content) that is inputted to generation system 30 as input data for content generation by generation system 30. The configuration of terminal T2 is similar to that of terminal T1. Terminal T2 holds the source content in its memory and can provide the source content to entities such as control system 20. Details of specific processing by terminal T2 will be described below.

Terminal T3 is an information processing device used by user U3 who purchases content (also referred to as generated content) generated by generation system 30. The configuration of terminal T3 is similar to that of terminal T1. Details of specific processing by terminal T3 will be described below.

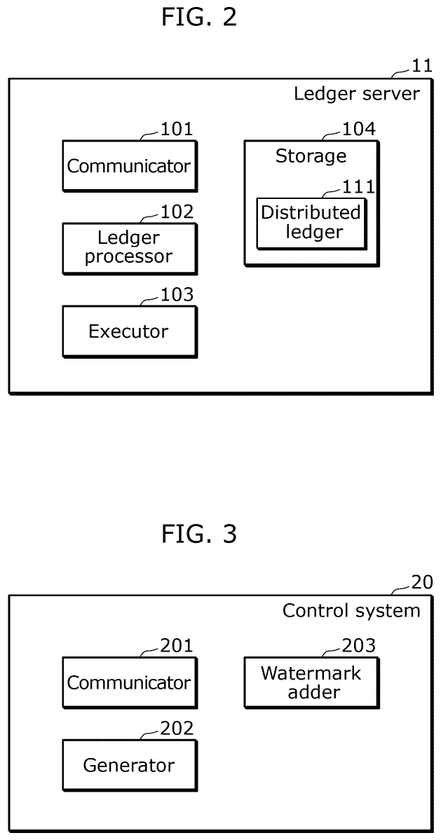

FIG. 2 is a block diagram illustrating the functional configuration of ledger server 11 in this embodiment.

As shown in FIG. 2, ledger server 11 includes, as functional units, communicator 101, ledger processor 102, executor 103, and storage 104. At least some of the functional units of ledger server 11 are implemented by a processor of ledger server 11 (e.g., a central processing unit (CPU)) executing a program using a memory.

Communicator 101 is a communication interface communicatively connected to network N. Communicator 101 may be a communication interface based on a wired communication standard, for example, Ethernet (registered trademark), or based on a wireless communication standard, for example, Wi-Fi (registered trademark) or a mobile communication system (e.g., 3G (Generation), 4G, or 5G). Communicator 101 is used by functional units of ledger server 11 to communicate with other devices.

Ledger processor 102 performs processing related to distributed ledger 111 and transaction data. Specifically, upon receiving transaction data from an entity such as generation system 30, ledger processor 102 performs control for verifying a digital signature in the received transaction data and storing the successfully verified transaction data in distributed ledger 111 held in storage 104. To store the transaction data in distributed ledger 111, ledger processor 102 can perform control for generating a block that includes the transaction data to be stored, and storing the block in distributed ledger 111 if agreement is made for the generated block with ledger processors 102 of the other ledger servers, i.e., ledger servers 12 and 13.

Executor 103 performs information processing. For example, executor 103 can perform information processing by executing a smart contract using distributed ledger 111. If a smart contract is not used, executor 103 performs information processing according to normal program code.

As the above information processing, executor 103 performs the processing of generating an NFT. The NFT corresponds one-to-one to legitimate content and includes, as metadata, related information on the legitimate content. The related information includes at least information indicating the owner of the legitimate content corresponding to the NFT.

Also as the above information processing, executor 103 performs the processing of transferring an NFT.

Storage 104 is a storage device for storing information. Storage 104 stores distributed ledger 111. Storage 104 may be implemented by a nonvolatile storage device, such as a solid state drive (SSD) or a hard disk drive (HDD).

Distributed ledger 111 stores data structured as chained blocks, each including one or more transaction data items. The one or more transaction data items stored in distributed ledger 111 include transaction data containing the contract code of a smart contract, transaction data containing the instruction to execute a smart contract, or transaction data containing other information. Specific data stored in distributed ledger 111 will be described in detail below.

FIG. 3 is a block diagram illustrating the functional configuration of control system 20 in this embodiment.

As shown in FIG. 3, control system 20 includes, as functional units, communicator 201, generator 202, and watermark adder 203. At least some of the functional units of control system 20 are implemented by a processor of control system 20 (e.g., a CPU) executing a program using a memory.

Communicator 201 is a communication interface communicatively connected to network N. Communicator 201 may be a communication interface based on a wired communication standard, for example, Ethernet (registered trademark), or based on a wireless communication standard, for example, Wi-Fi (registered trademark) or a mobile communication system (e.g., 3G, 4G, or 5G). Communicator 201 is used by functional units of control system 20 to communicate with other devices.

Generator 202 generates information (also referred to as an NFT generation request) requesting the generation of an NFT corresponding one-to-one to legitimate content. Generator 202 transmits the generated NFT generation request to ledger system 10 via communicator 201.

Watermark adder 203 adds a digital watermark to legitimate content. Specifically, watermark adder 203 adds, to legitimate content, information (also referred to as legitimacy information) indicating that the content is legitimate as content to be inputted to model 304, which is a trained model. More specifically, watermark adder 203 adds legitimacy information (corresponding to third legitimacy information), as a digital watermark, to content (corresponding to training content or third content) to be inputted to the machine learning model as training data for model 304. Watermark adder 203 also adds legitimacy information (corresponding to first legitimacy information), as a digital watermark, to content (corresponding to source content or first content) to be inputted to model 304 as input data for content generation by model 304.

Now, generation system 30 will be described.

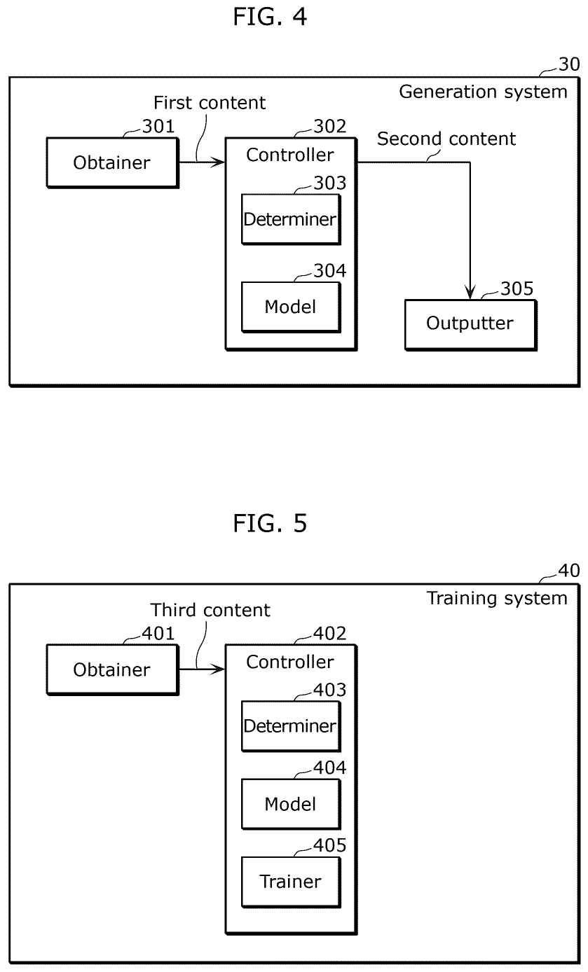

FIG. 4 is a block diagram illustrating the functional configuration of generation system 30 in this embodiment.

As shown in FIG. 4, generation system 30 includes, as functional units, obtainer 301, controller 302, and outputter 305. At least some of the functional units of generation system 30 are implemented by a processor of generation system 30 (e.g., a CPU) executing a program using a memory.

Obtainer 301 obtains content (corresponding to the first content). The content obtained by obtainer 301 is used as input data for content generation by model 304. Obtainer 301 provides the obtained content to controller 302.

If the content obtained by obtainer 301 is legitimate as content to be inputted to model 304, which is a trained model, the content contains the first legitimacy information as a digital watermark. In that case, distributed ledger 111 contains an NFT (corresponding to a first NFT) corresponding one-to-one to the content obtained by obtainer 301.

Controller 302 obtains content (corresponding to generated content or second content) generated by model 304, using the content provided by obtainer 301. Controller 302 includes determiner 303 and model 304.

Determiner 303 determines whether the content provided by obtainer 301 contains the first legitimacy information as a digital watermark.

Model 304 is a trained machine learning model. For example, model 304 may be a neural network model and may adopt an architecture such as a generative adversarial network (GAN) or a diffusion model. Model 304 is a trained machine learning model trained using content (corresponding to the third content) that contains, as a digital watermark, legitimacy information (corresponding to the third legitimacy information) indicating that the content is legitimate as content to be inputted to model 304. Trained model 304 generates and outputs content (corresponding to fifth content) based on content (corresponding to fourth content) inputted to model 304. The fifth content generated is content obtained by adding, to the fourth content inputted to model 304, a feature that is based on the training that model 304 has undergone. Model 304 may be, although not limited to, model 404 (to be described below) trained by training system 40.

If determiner 303 determines that the content provided by obtainer 301 contains the first legitimacy information, controller 302 inputs the content to model 304 to obtain second content generated by model 304. By contrast, if determiner 303 determines that the content provided by obtainer 301 does not contain the first legitimacy information, controller 302 does not input the content to model 304. As a result, controller 302 does not output content generated by model 304 (in other words, prohibits outputting content generated by model 304).

When the content generated by model 304 is obtained, controller 302 may cause second legitimacy information to be added as a digital watermark to the content. Here, the second legitimacy information is information indicating that the content is legitimate content outputted by model 304.

Furthermore, when controller 302 obtains content generated by model 304, controller 302 causes a second NFT, corresponding one-to-one to the content, to be stored in distributed ledger 111. The operator of generation system 30 is associated with the second NFT as the owner of the second NFT.

Controller 302 also controls a purchase process for generated content. The purchase process is performed when a user purchases generated content generated by model 304. The purchase process includes processing for storing, in distributed ledger 111, purchase transaction data indicating the purchase of the generated content by the user, and transfer transaction data indicating that value information is transferred as the price for the purchase. The value information is, for example, tokens serving as value information managed by distributed ledger 111. Although the following description illustrates such tokens as an example, this is not limitation and the value information may be cryptocurrency. Details will be described below.

Outputter 305 outputs the content obtained by controller 302 (i.e., the content generated using model 304). Specifically, outputter 305 can output the content by transmitting the content to an external device through a communication line, or by causing the content to be stored in a removable storage device from generation system 30. The content outputted by outputter 305 contains second legitimacy information.

Now, training system 40 will be described. Training system 40 is an information processing system that trains a machine learning model.

FIG. 5 is a block diagram illustrating the functional configuration of training system 40 in this embodiment.

As shown in FIG. 5, training system 40 includes, as functional units, obtainer 401 and controller 402. At least some of the functional units of training system 40 are implemented by a processor of training system 40 (e.g., a CPU) executing a program using a memory.

Obtainer 401 obtains content (corresponding to training content or the third content). The content obtained by obtainer 401 is used as training data for model 404. Obtainer 401 provides the obtained content to controller 402.

If the content obtained by obtainer 401 is legitimate as content to be inputted to model 404, which is a machine learning model, the content contains the third legitimacy information as a digital watermark. In that case, distributed ledger 111 contains an NFT (corresponding to a third NFT) corresponding one-to-one to the content obtained by obtainer 401.

Controller 402 trains model 404 using the content provided by obtainer 401. Controller 402 includes determiner 403, model 404, and trainer 405.

Determiner 403 determines whether the content provided by obtainer 401 contains the third legitimacy information as a digital watermark. The third legitimacy information indicates that content provided by obtainer 401 is legitimate as content to be inputted to the machine learning model (in other words, model 404).

Model 404 is a machine learning model to be trained by training system 40. Model 404 is trained by trainer 405 using training content that contains, as a digital watermark, the third legitimacy information indicating that the content is legitimate as a content to be inputted to model 404. The training content will be described below. For example, model 404 may be a neural network model and may adopt an architecture such as a GAN or a diffusion model. Model 404 is trained by trainer 405 so that factors (weights) in the neural network model are adjusted.

If determiner 403 determines that the content provided by obtainer 401 contains the third legitimacy information, trainer 405 trains model 404 to generate and output fifth content based on fourth content inputted to model 404. The fifth content is content obtained by adding, to the fourth content, a feature that is based on the training that model 404 has undergone.

It should be noted that training system 40 may be incorporated in generation system 30 as a function of generation system 30. In that case, the functions of obtainer 401 may be incorporated in obtainer 301, and the functions of controller 402 may be incorporated in controller 302.

Now, an addition process for adding legitimacy information to content will be described. Content to which legitimacy information is to be added may be training content or source content.

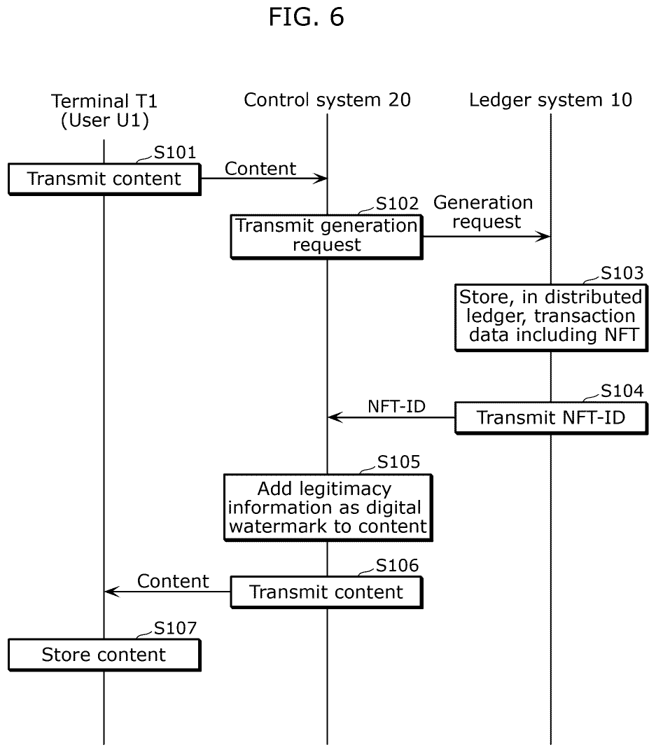

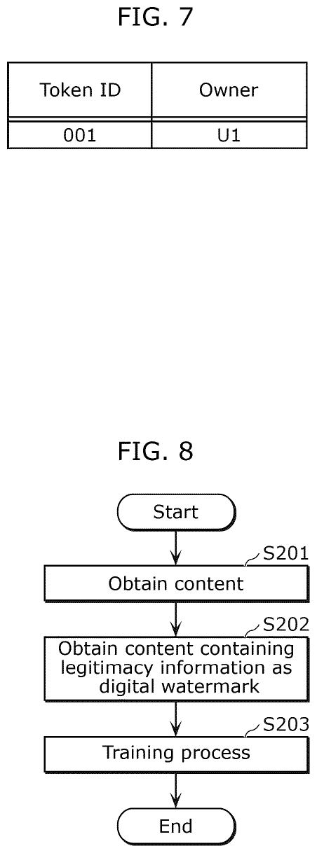

FIG. 6 is a sequential diagram illustrating an addition process for adding legitimacy information to content in this embodiment. FIG. 7 is an explanatory diagram illustrating a first example of NFT metadata in this embodiment.

The description here illustrates an example of an addition process for adding legitimacy information (corresponding to the third legitimacy information) to training content, which is an example of content, held in terminal T1. The description also applies to an addition process for adding legitimacy information (the first legitimacy information) to source content, which is another example of content, held in terminal T2. In that case, terminal T1 shown in FIG. 6 is replaced by terminal T2.

At step S101, terminal T1 transmits content to control system 20. Terminal T1 may transmit the content to control system 20 in response to receiving a content obtainment request from control system 20, or autonomously (in other words, without receiving an obtainment request from control system 20). Control system 20 receives the transmitted content.

At step S102, generator 202 of control system 20 generates generation request information (also referred to as a generation request) requesting the generation of an NFT, and transmits the generation request to ledger system 10. The generation request is information for requesting the generation of an NFT corresponding one-to-one to the content received at step S101. Ledger system 10 receives the transmitted generation request.

At step S103, in response to receiving the generation request at step S102, ledger system 10 generates transaction data including an NFT and stores the transaction data in distributed ledger 111. The transaction data including the NFT may be considered transaction data indicating the generation of the NFT. Storing the transaction data including the NFT in distributed ledger 111 causes the NFT to be generated. To generate the NFT, ledger system 10 generates a token ID (also referred to as an NFT-ID), which is the identification information of the NFT, and assigns the token ID to the NFT. FIG. 7 illustrates an example of metadata of the generated NFT. The metadata shown in FIG. 7 is the metadata of an NFT having the token ID “001” and indicates owner information “U1” (i.e., user U1). The metadata may be stored in storage device 5.

At step S104, ledger system 10 transmits the NFT-ID generated at step S103 to control system 20. Control system 20 receives the transmitted NFT-ID.

At step S105, watermark adder 203 of control system 20 adds legitimacy information as a digital watermark to the content received at step S101. The legitimacy information includes the NFT-ID received at step S104.

At step S106, watermark adder 203 of control system 20 transmits, to terminal T1, the content that contains the legitimacy information added at step S105. Terminal T1 receives the transmitted content. It should be noted that control system 20 may transmit the content as a response to the reception of the content at step S101.

At step S107, terminal T1 stores the content received at step S106 in the storage device of terminal T1. Terminal T1 may store the content received at step S106 in storage device 5. The content stored in storage device 5 can be accessed by other devices through network N.

The generation request transmitted at step S102 may be transaction data (also referred to as generation request transaction data). In that case, ledger system 10 receives the transmitted generation request transaction data and stores it in distributed ledger 111. The processing at steps S103 and S104 may then be performed according to a smart contract based on the storage of the generation request transaction data in distributed ledger 111 at step S102. The generation request transaction data may thus include an instruction to execute a smart contract for performing the above process. Based on the storage of the generation request transaction data in distributed ledger 111 (step S102), executor 103 can perform the above process according to the instruction.

Now, a training process for training a machine learning model will be described. The training process is performed by training system 40.

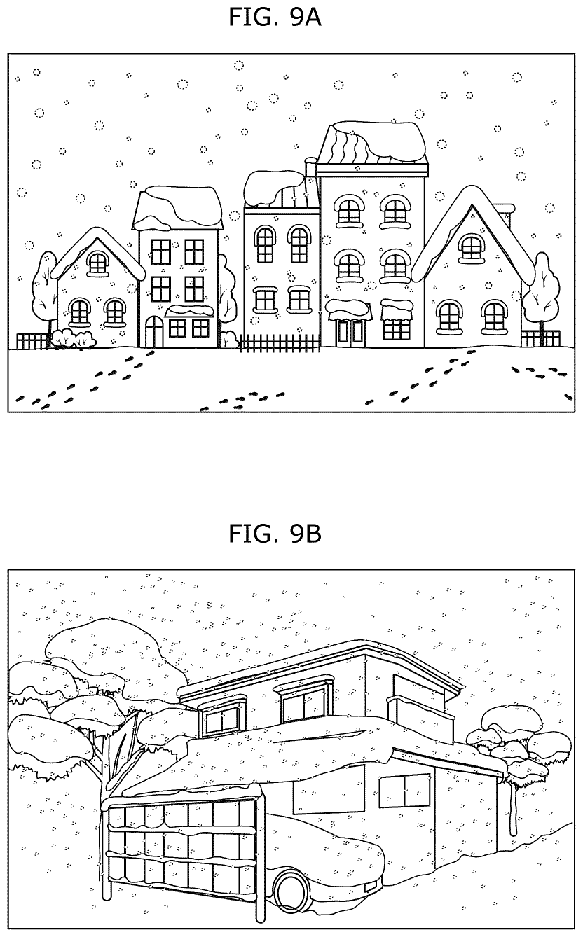

FIG. 8 is a flowchart illustrating a training process for a machine learning model in this embodiment. FIGS. 9A and 9B are explanatory diagrams illustrating examples of training content in this embodiment.

At step S201 shown in FIG. 8, obtainer 401 obtains content (corresponding to training content). For example, obtainer 401 may obtain several thousands to several tens of thousands of content items. Obtainer 401 provides the obtained content to controller 402.

The content obtained by obtainer 401 may belong to a group of content items having a specific feature. For example, the content obtained by obtainer 401 may be photographic images depicting scenes under a specific weather condition (e.g., clear weather, rainfall, snowfall, or thunderbolts), illustration images depicting the above scenes, photographic images depicting specific subjects (such as persons with a specific attribute, specific animals, or objects with a specific function), illustration images depicting specific subjects, or illustration images drawn with a specific touch (such as style, color tone, or technique).

FIGS. 9A and 9B illustrate examples of training content obtained by obtainer 401 as content having the specific content feature “a snowfall weather condition.”

FIG. 9A shows a photographic image depicting a snowfall scene, featuring falling snow and buildings with snow thereon. FIG. 9B shows a photographic image depicting a snowfall scene, featuring falling snow and objects, such as a house, car, and garage, with snow thereon.

At step S202, determiner 403 obtains, from among the content items obtained at step S201, content items containing the third legitimacy information as a digital watermark. Specifically, determiner 403 determines whether each of the content items obtained at step S201 contains the third legitimacy information as a digital watermark, and obtains content items determined to contain the third legitimacy information as a digital watermark.

At step S203, trainer 405 performs a training process for model 404 using the content determined to contain the third legitimacy information as a digital watermark at step S202. Model 404, which is a machine learning model subjected to the training process at step S203, may be referred to as a trained model. Model 404 may be used as model 304.

Now, a generation process for generation system 30 to generate content using model 304 will be described.

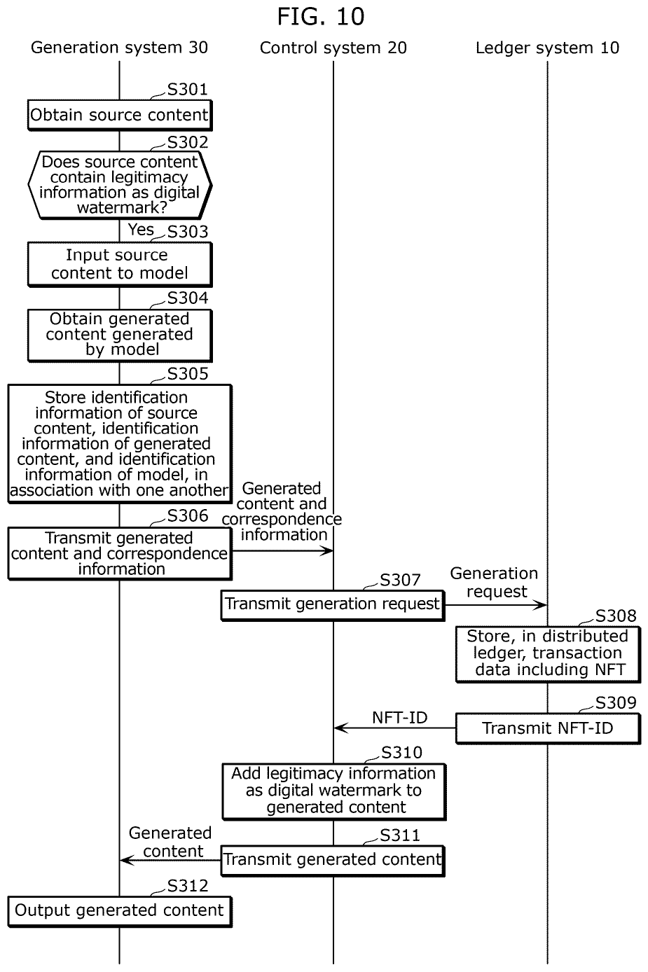

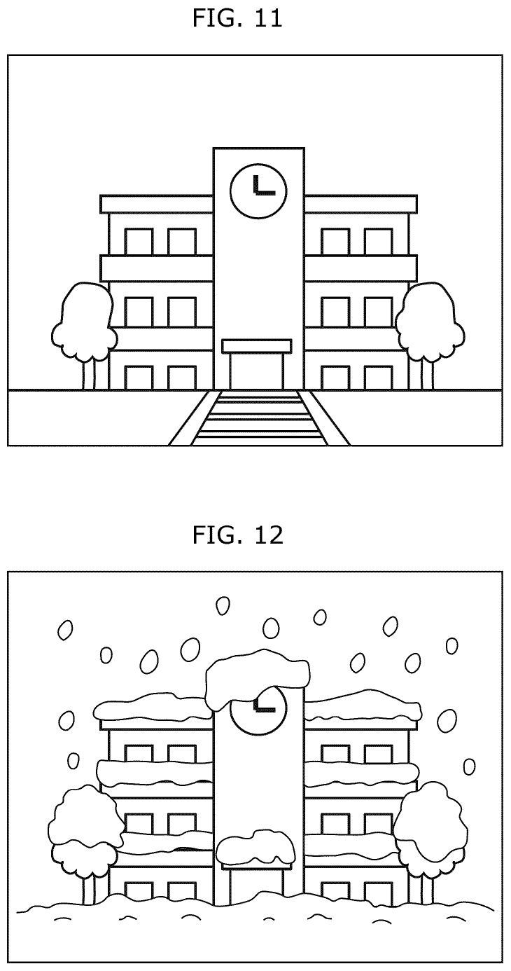

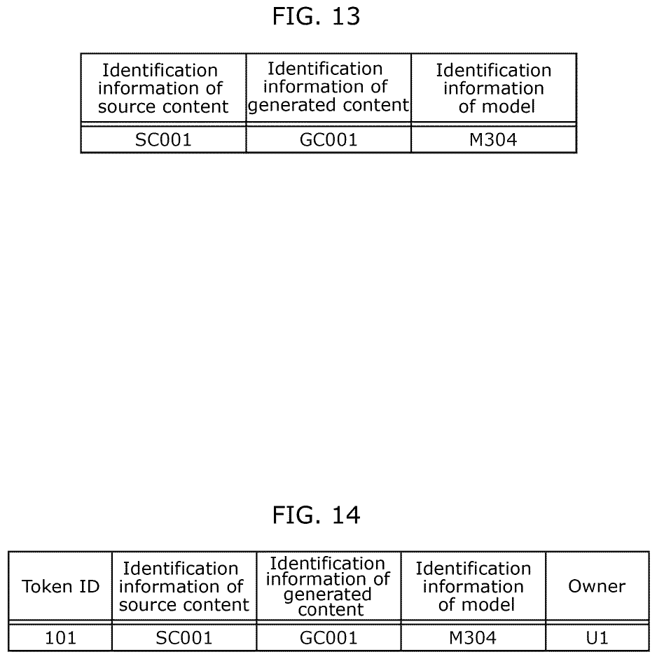

FIG. 10 is a sequential diagram illustrating a generation process for generating content in this embodiment. FIG. 11 is an explanatory diagram illustrating an example of source content in this embodiment. FIG. 12 is an explanatory diagram illustrating an example of generated content in this embodiment. FIG. 13 is an explanatory diagram illustrating correspondence information in this embodiment. FIG. 14 is an explanatory diagram illustrating NFT metadata in this embodiment.

At step S301 shown in FIG. 10, obtainer 301 obtains source content (corresponding to the first content). The owner of the source content obtained by obtainer 301 is, for example, user U1 of terminal T1. The following description assumes that user U1 is the owner, as an example. Obtainer 301 may obtain one or more content items. Obtainer 301 provides the obtained content to controller 302.

FIG. 11 illustrates an example of the source content. The source content shown in FIG. 11 is an illustration image depicting a building under a clear weather condition.

At step S302, determiner 303 of generation system 30 determines whether the source content obtained at step S301 contains the first legitimacy information as a digital watermark. If the source content is determined to contain the first legitimacy information as a digital watermark (step S302: Yes), the process proceeds to step S303. If the source content is determined not to contain the first legitimacy information as a digital watermark, the process shown in this sequential diagram terminates without generating content. For convenience of description, the diagram does not show steps for the source content determined not to contain legitimacy information as a digital watermark.

At step S303, controller 302 of generation system 30 inputs the source content obtained at step S301 to model 304.

At step S304, controller 302 of generation system 30 obtains content (corresponding to generated content or the second content) generated by model 304 as a result of inputting the source content to model 304 at step S303.

FIG. 12 illustrates an example of the generated content. The generated content shown in FIG. 12 is an illustration depicting a building similar to the building in FIG. 11 but under a snowfall weather condition. This content results from adding, to the source content shown in FIG. 11, the feature “a snowfall weather condition” that is based on the training performed by model 304.

At step S305, controller 302 of generation system 30 stores correspondence information that includes the identification information of the source content obtained at step S301, the identification information of the generated content obtained at step S304, and the identification information of model 304, associated with one another.

FIG. 13 illustrates an example of the correspondence information. The correspondence information shown in FIG. 13 indicates the identification information “SC001” of the source content, the identification information “GC001” of the generated content, and the identification information “M304” (i.e., model 304) of the model, associated with one another.

At step S306, controller 302 of generation system 30 transmits, to control system 20, the generated content obtained at step S304 and the correspondence information stored at step S305. Control system 20 receives the transmitted generated content and correspondence information.

At step S307, generator 202 of control system 20 generates generation request information (also referred to as a generation request) requesting the generation of an NFT, and transmits the generation request to ledger system 10. The generation request is information for requesting the generation of an NFT corresponding one-to-one to the generated content received at step S306. The generation request includes at least the correspondence information. Ledger system 10 receives the transmitted generation request.

At step S308, in response to receiving the generation request at step S307, ledger system 10 generates transaction data including an NFT and stores the transaction data in distributed ledger 111. The transaction data including the NFT may be considered transaction data indicating the generation of the NFT. Storing the transaction data including the NFT in distributed ledger 111 causes the NFT to be generated. To generate the NFT, ledger system 10 generates a token ID (also referred to as an NFT-ID), which is the identification information of the NFT, and assigns the token ID to the NFT. The generated NFT includes, as metadata, the correspondence information included in the generation request received at step S307. The metadata may be stored in storage device 5.

FIG. 14 illustrates an example of the metadata. The metadata shown in FIG. 14 is the metadata of an NFT having the token ID “001” and includes the correspondence information shown in FIG. 13 (specifically, the identification information “SC001” of the source content, the identification information “GC001” of the generated content, and the identification information “M304” of the model), and owner information “U1” (i.e., user U1).

At step S309, ledger system 10 transmits the NFT-ID generated at step S308 to control system 20. Control system 20 receives the transmitted NFT-ID.

At step S310, watermark adder 203 of control system 20 adds the second legitimacy information as a digital watermark to the generated content received at step S306. The second legitimacy information includes the NFT-ID received at step S309.

At step S311, watermark adder 203 of control system 20 transmits, to generation system 30, the generated content that contains the second legitimacy information added at step S310. Generation system 30 receives the transmitted generated content. It should be noted that watermark adder 203 may transmit the generated content as a response to the reception of the content at step S306.

At step S312, outputter 305 of generation system 30 outputs the generated content received at step S311. Outputting the generated content may include, for example, transmitting the generated content to terminal T1 that has provided the source content. In that case, the generated content may be transmitted as a response to the reception of the source content at step S301. Outputting the generated content may also include transmitting the generated content to another device. Outputting the generated content may further include, for example, displaying the generated content on a display of generation system 30 or of another device.

The generation request transmitted at step S307 may be transaction data (also referred to as generation request transaction data). In that case, ledger system 10 receives the transmitted generation request transaction data and stores it in distributed ledger 111. The processing at steps S308 and S309 may then be performed according to a smart contract based on the storage of the generation request transaction data in distributed ledger 111 at step S307. The generation request transaction data may thus include an instruction to execute a smart contract for performing the above process. Based on the storage of the generation request transaction data in distributed ledger 111 (step S307), executor 103 can perform the above process according to the instruction.

Now, a purchase process performed when generated content is purchased will be described. It should be noted that the word “purchase” may also be expressed as “transfer.”

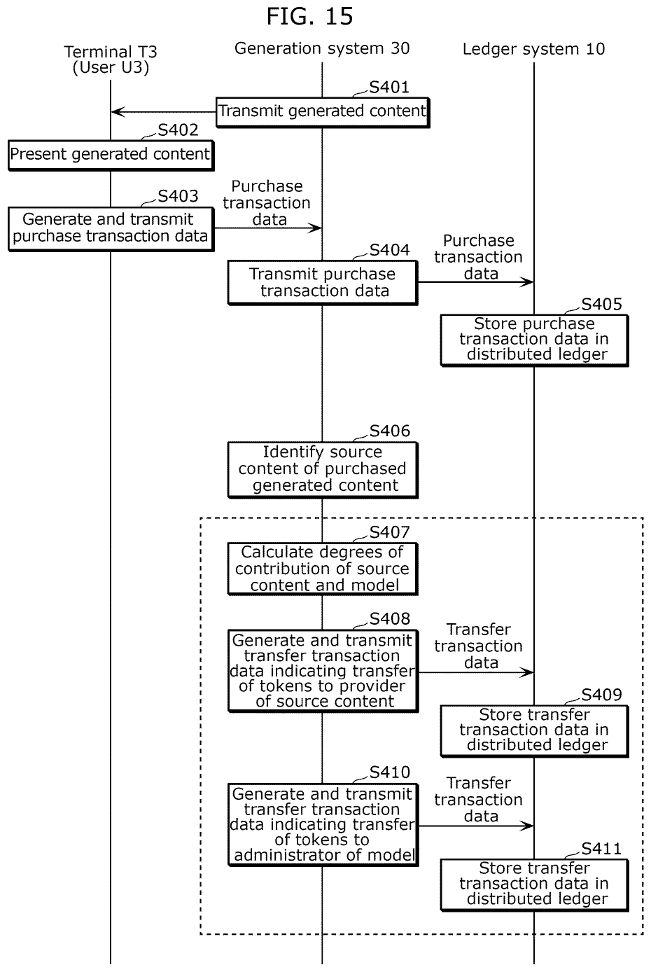

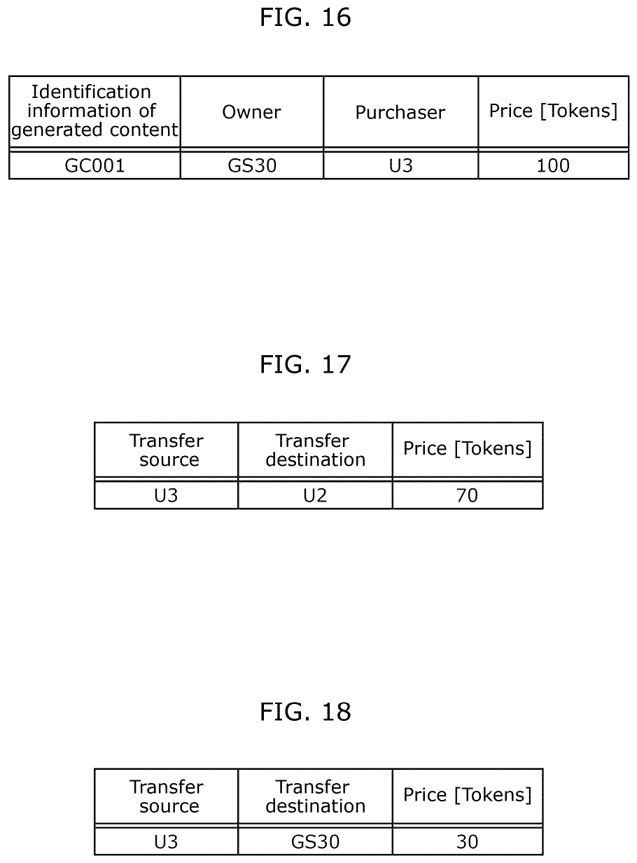

FIG. 15 is a sequential diagram illustrating a purchase process for generated content in this embodiment. FIG. 16 is an explanatory diagram illustrating an example of purchase transaction data in this embodiment. FIGS. 17 and 18 are explanatory diagrams illustrating examples of transfer transaction data in this embodiment.

The description here illustrates an example of a purchase process performed when user U3 purchases generated content generated by generation system 30. The purchase process includes processing for transferring the ownership of the generated content, and processing for providing the price for the purchase. The price for the purchase is provided from user U3 to user U2, i.e., the provider of the source content, and to the administrator of the model.

The process in FIG. 15 is assumed to be performed while generation system 30 has obtained and holds the generated content.

The example below assumes that user U3 first views the generated content before purchasing it. If user U3 purchases the generated content without viewing it at all, steps S401 and S402 below may be skipped.

At step S401, generation system 30 transmits generated content to terminal T3. Generation system 30 may transmit the generated content to terminal T3 in response to receiving an obtainment request for generated content from terminal T3, or autonomously (in other words, without receiving an obtainment request from terminal T3). Terminal T3 receives the transmitted generated content.

At step S402, terminal T3 presents the generated content received at step S401. For example, if the generated content is image content, terminal T3 displays the image content on a display screen; if the generated content is audio content, terminal T3 outputs the audio content as sound through a speaker. The presented generated content is expected to be perceived by the user. The user, perceiving the generated content, is expected to desire to purchase the generated content (in other words, to be the owner of the generated content).

The following will describe a process performed if user U3 desires to purchase the generated content. If user U3 desires to purchase the generated content, user U3 performs an operation on terminal T3 to start the process of purchasing the generated content. This operation is, for example, an action on an operation button displayed on terminal T3 along with the presentation of the generated content. In response to this operation, terminal T3 performs the following process.

At step S403, terminal T3 generates transaction data (also referred to as purchase transaction data) indicating the purchase of the generated content by user U3 and transmits the purchase transaction data to generation system 30. Generation system 30 receives the transmitted purchase transaction data.

FIG. 16 illustrates an example of the purchase transaction data generated by terminal T3.

The purchase transaction data shown in FIG. 16 includes at least the identification information of the generated content; information indicating the owner of the generated content; information indicating the purchaser of the generated content; and the quantity of tokens, indicating the price for the purchase (see FIG. 16).

For example, the above data is set as follows. The identification information of the generated content is “GC001,” the information indicating the owner of the generated content is “GS30” (i.e., generation system 30), the information indicating the purchaser of the generated content is “U3” (i.e., user U3), and the quantity of tokens indicating the price for the purchase is “100” (i.e., 100 tokens).

At step S404, generation system 30 performs control for storing the purchase transaction data received at step S403 in distributed ledger 111 of ledger system 10. Specifically, generation system 30 transmits the purchase transaction data received at step S403 to ledger system 10. Ledger system 10 receives the transmitted purchase transaction data.

At step S405, ledger system 10 stores the purchase transaction data received at step S404 in distributed ledger 111. Once the purchase transaction data is stored in distributed ledger 111, the owner of the NFT corresponding to the generated content is changed from the operator, i.e., the current owner of the generated content, to user U3, i.e., the purchaser of the generated content.

At step S406, generation system 30 identifies the source content of the purchased generated content, i.e., data inputted to model 304 for generating the generated content. Generation system 30 can identify the source content by referring to the metadata of the purchased generated content and obtaining “the identification information of the source content” in the metadata.

At step S407, generation system 30 calculates the degrees of contribution of the source content and model 304 to the generated content. For example, generation system 30 calculates the degree of similarity between the generated content and the source content. Generation system 30 can regard the calculated degree of similarity as the degree of contribution of the source content to the generated content. Generation system 30 can then subtract the degree of contribution of the source content from the total (100%) to obtain the degree of contribution of model 304 to the generated content (see Equation 1 below).

the degree of contribution of model 304=100%−the degree of contribution of the source content (Equation 1)

For example, generation system 30 may calculate the degree of similarity between the generated content and the source content as 70%. Generation system 30 can then determine the degree of contribution of the source content to the generated content to be 70%, and the degree of contribution of model 304 to the generated content to be 30%.

At step S408, generation system 30 performs control for storing transaction data (also referred to as first transfer transaction data) in distributed ledger 111 of ledger system 10. The first transfer transaction data indicates that tokens are transferred from user U3, i.e., the purchaser of the generated content, to user U2, i.e., the provider of the source content. Specifically, generation system 30 generates the first transfer transaction data and transmits it to ledger system 10. Ledger system 10 receives the transmitted first transfer transaction data. The tokens to be transferred are a portion (also referred to as a first portion) of the tokens paid by user U3 to the operator of generation system 30.

FIG. 17 illustrates an example of the first transfer transaction data generated by generation system 30 at step S408.

The first transfer transaction data shown in FIG. 17 includes the token transfer source, the token transfer destination, and the quantity of tokens transferred. Specifically, the data indicates the token transfer source “U3” (i.e., user U3), the token transfer destination “U2” (i.e., user U2), and the quantity of tokens transferred “70” (i.e., 70 tokens).

At step S409, ledger system 10 stores the transfer transaction data received at step S408 in distributed ledger 111.

At step S410, generation system 30 performs control for storing transaction data (also referred to as second transfer transaction data) in distributed ledger 111 of ledger system 10. The second transfer transaction data indicates that tokens are transferred from user U3, i.e., the purchaser of the generated content, to the operator of generation system 30. Specifically, generation system 30 generates the second transfer transaction data and transmits it to ledger system 10. Ledger system 10 receives the transmitted second transfer transaction data. The tokens to be transferred are the portion (also referred to as a second portion) remaining after subtracting the first portion from the tokens paid by user U3 to the operator of generation system 30.

FIG. 18 illustrates an example of the second transfer transaction data generated by generation system 30 at step S410.

The second transfer transaction data shown in FIG. 18 includes the token transfer source, the token transfer destination, and the quantity of tokens transferred. Specifically, the data indicates the token transfer source “U3” (i.e., user U3), the token transfer destination “GS30” (i.e., generation system 30), and the quantity of tokens transferred “30” (i.e., 30 tokens).

At step S411, ledger system 10 stores the transfer transaction data received at step S410 in distributed ledger 111.

For a greater contribution of the source content to the generation of the generated content, generation system 30 may determine the first portion to be a greater portion of the total tokens paid by user U3 to the operator of generation system 30. Generation system 30 may then determine the second portion of the tokens to be the portion remaining after subtracting the first portion from the total tokens paid by user U3 to the operator of generation system 30. Generation system 30 may determine the contribution of the source content to the generation of the generated content to be a greater value as the similarity between the generated content and the source content is higher.

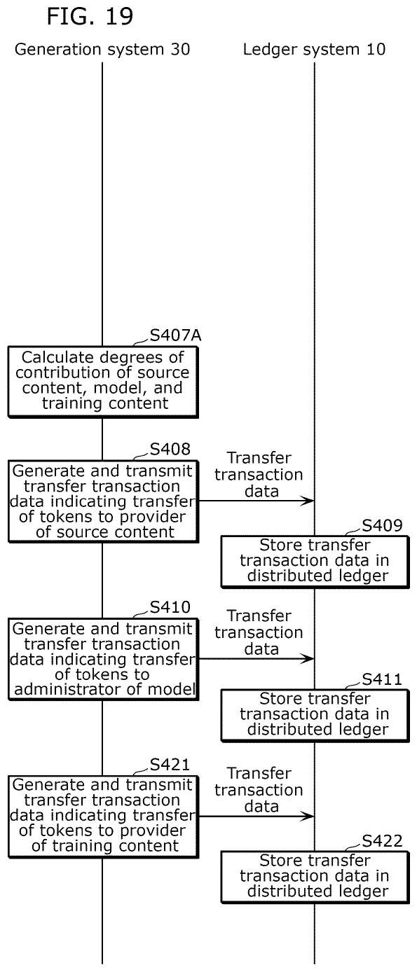

FIG. 19 is a sequential diagram illustrating a variation of the purchase process for generated content in this embodiment. The process illustrated in FIG. 19 is a variation of the process within the dashed frame in FIG. 15.

The description here illustrates another example of the purchase process performed when user U3 purchases generated content generated by generation system 30. The purchase process includes processing for transferring the ownership of the generated content, and processing for providing the price for the purchase. The price for the purchase is provided from user U3 to user U2, i.e., the provider of the source content, to the administrator of model 304, and to user U1, i.e., the provider of the training content.

At step S407A, generation system 30 calculates the degrees of contribution of the source content, model 304, and the training content, to the generated content. For example, generation system 30 calculates the degree of similarity between the generated content and the source content. Generation system 30 can regard the calculated degree of similarity as the degree of contribution of the source content to the generated content (see Equation 1).

Generation system 30 can subtract the degree of contribution of the source content from the total (100%) to obtain the degree of contribution of model 304 and the training content to the generated content (see Equation 2 below).

the degree of contribution A of model 304 and the training content=100%−the degree of contribution of the source content (Equation 2)

The individual degrees of contribution of model 304 and the training content may then be determined according to, for example, a predetermined ratio (e.g., the degree of contribution of model 304:the degree of contribution of the training content=5:5, or 2:3) (see Equations 3 and 4 below).

the degree of contribution of model 304=A×the contribution rate of model 304 (Equation 3)

the degree of contribution of the training content=A×the contribution rate of the training content (Equation 4)

For example, generation system 30 may calculate the degree of similarity between the generated content and the source content as 70%. The contribution ratio between model 304 and the training content may be 5:5. Generation system 30 may then determine the degrees of contribution of the source content, model 304, and the training content to the generated content to be 70%, 15%, and 15%, respectively.

If the provider of the training content consists of multiple providers, the degree of contribution may be divided among the providers proportionally to the number of training content items provided by each provider. For example, if 10000 training content items were used to train model 304 and the degree of contribution of the training content to the generated content is 15%, the provider of 1000 training content items may be assigned a degree of contribution of 1.5%, whereas the provider of 9000 training content items may be assigned a degree of contribution of 13.5%.

Steps S408 to S411 are the same as the steps labeled with the same numerals in FIG. 15, except that the value calculated at step S407A is used as the quantity of tokens in the second transfer transaction data generated at step S410.

At step S421, generation system 30 generates transaction data (also referred to as third transfer transaction data), indicating that tokens are transferred to the provider of the training content, and transmits the transfer transaction data to ledger system 10. Ledger system 10 receives the transmitted transfer transaction data.

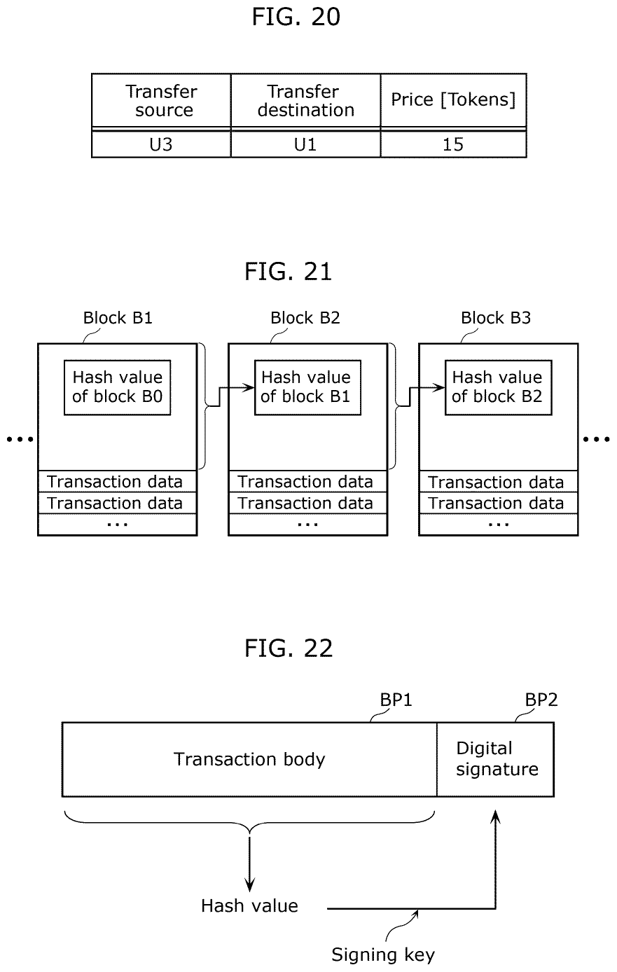

FIG. 20 illustrates an example of the third transfer transaction data generated by generation system 30 at step S421.

The third transfer transaction data shown in FIG. 20 includes the token transfer source, the token transfer destination, and the quantity of tokens transferred. Specifically, the token transfer source is “U3” (i.e., user U3), the token transfer destination is “U1” (i.e., user U1), and the quantity of tokens transferred is “15” (i.e., 15 tokens) (see FIG. 20).

At step S422, ledger system 10 stores the transfer transaction data received at step S421 in distributed ledger 111.

If the provider of the training content consists of multiple providers, transfer transaction data may be generated at step S421 for transferring tokens to each of the multiple providers. The quantity of tokens to be transferred to each provider may be determined based on the number of training content items provided by that provider (e.g., proportionally to the number of training content items provided by that provider). Alternatively, the quantity of tokens to be transferred to each provider may be set to a fixed value regardless of the number of training content items provided by that provider.

### Description of Distributed Ledger System

Ledger system 10 in the above description (also referred to as a distributed ledger system) will be described in detail below.

The distributed ledger system is a system that stores and maintains information by means of a peer to peer (P2P) network technique for a plurality of nodes connected together. Each of the nodes is an information processing device in which a processor (e.g., a CPU) executes a program using a memory to perform predetermined processing.

In the distributed ledger system, the plurality of nodes maintain identical copies of information and continuously synchronize the information in an autonomous and distributed manner. This enables the distributed ledger system to store information appropriately while substantially preventing the information from being tampered with, without a privileged node (e.g., a centralized server or a server in a client-server model).

A device to access a distributed ledger is only required to access any one of the plurality of nodes included in the distributed ledger system. In other words, the device need not access a few devices such as centralized servers. Therefore, the concentration of a communication load or processing load on a centralized server, which can occur in a centralized system, is avoided. This produces such advantages that the resources of the nodes (the CPUs, the memories, etc.) are not required to have particularly high-performance specifications, and that communication lines to which the nodes are connected are not required to have particularly large communication capacities. This enables the distributed ledger system to be constituted by ordinary (or general-purpose) nodes or communication lines and can contribute to the effect of reducing necessary computer resources or communication resources or reducing the costs necessary for nodes or communication lines.

In addition, a distributed ledger system is capable of storing information with high fault tolerance or allowing information to be referred to with high fault tolerance. In general, a plurality of nodes included in a distributed ledger system are arranged being physically distributed or being distributed across the network. A distributed ledger system stops if a plurality of nodes included in the distributed ledger system all stop. However, it is rare for the distributed ledger system to stop because it is rare for all of the plurality of nodes physically distributed or distributed across the network to stop. This is considered to be an advantage over a centralized system, which can fail to store information or fail to allow information to be referred to when stopping.

With reference to FIG. 21 to FIG. 25, the data structure of a distributed ledger, the execution of a smart contract, and the data structure of an NFT will be described.

FIG. 21 is an explanatory diagram illustrating the data structure of a blockchain, which is an example of the distributed ledger.

In the blockchain, blocks, which are recording units of the blockchain, are connected to form a chain. Each of the blocks includes a plurality of transaction data items and the hash value of its previous block.

FIG. 21 illustrates blocks B1, B2, and B3 included in the blockchain.

For example, block B2 includes the hash value of block B1, the previous block. The hash value of block B1 is a hash value calculated by computation performed on the content of block B1 according to a hash algorithm.

Block B3 includes a hash value calculated from the plurality of transaction data items included in block B2 and the hash value of block B1, as the hash value of block B2.

As seen from the above, the blockchain has the configuration in which the blocks each including the content of its previous block in the form of a hash value are connected to form a chain. Thus, the blockchain can effectively prevent tampering with recorded transaction data.

If past transaction data is altered (in other words, tampered with), the hash value of the block including the transaction data differs from the value before the alteration. In this case, in order to make the block including the altered transaction data appear authentic, it is necessary to rebuild all the blocks following the block, which includes the altered transaction data, in the distributed ledger stored in each of multiple servers. This task is extremely difficult in reality. These characteristics can make it substantially impossible to tamper with transaction data included in a blockchain.

It should be noted that, to store transaction data in a blockchain, a node generates a block including the transaction data to be stored and executes processing based on a consensus algorithm for the generated block with the other nodes to reach a consensus with them. When the consensus is reached, the node performs control to store the block in the blockchain. In this manner, a plurality of nodes operating in an autonomous and distributed manner can connect a valid block to the blockchain. As the consensus algorithm, practical byzantine fault tolerance (PBFT) may be used, or proof of work (PoW), proof of stake (PoS), or the like may be used. Note that, in the case where Hyperledger fabric is used as an example of a distributed ledger technology, the consensus algorithm need not be executed.

FIG. 22 is an explanatory diagram illustrating the data structure of transaction data.

Transaction data illustrated in FIG. 22 includes transaction body BP1 and digital signature BP2 (will also be referred to simply as a signature). Transaction body BP1 is the data body included in the transaction data. Digital signature BP2 is generated by encrypting the hash value of transaction body BP1 with a signing key of the creator of the transaction data (in other words, a private key).

Using digital signature BP2 included in the transaction data, a node receiving the transaction data can verify whether transaction body BP1 is valid (in other words, it is not tampered with). This can make it substantially impossible to tamper with the data included in transaction body BP1. In addition, by storing the transaction data that has been successfully verified in a blockchain, it is possible to maintain the validity of the transaction data stored in the blockchain.

In the above-described manner, transaction data included in a blockchain are stored in the blockchain in such a manner that the transaction data are linked together using the hash values of the transaction data and hash values of blocks. As a result, the transaction data included in the blockchain are stored and maintained being substantially free from tampering. This is an advantage over a database or a distributed database, in which a collection of data is simply stored.

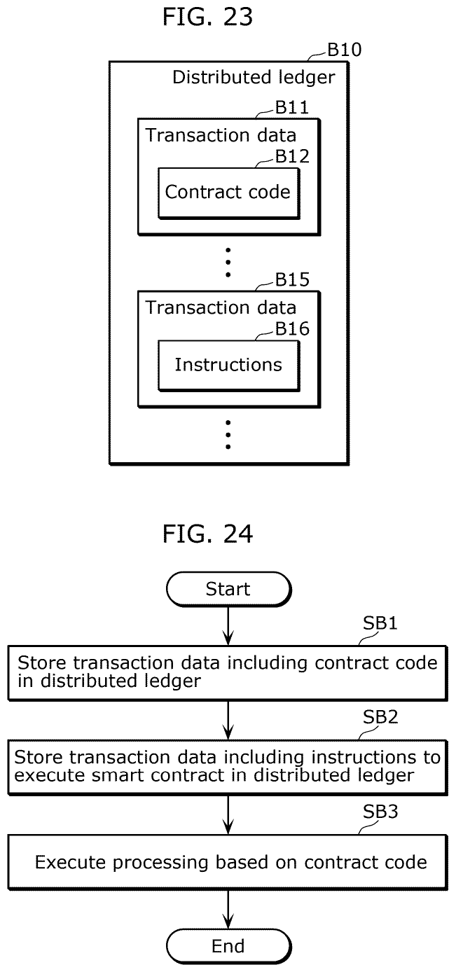

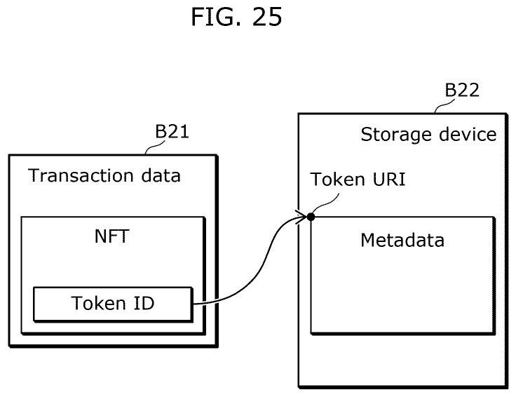

FIG. 23 is an explanatory diagram illustrating transaction data pertaining to the execution of a smart contract. FIG. 24 is an explanatory diagram illustrating processing pertaining to the execution of a smart contract.

With reference to FIG. 23 and FIG. 24, a series of steps pertaining to the execution of the smart contract using a distributed ledger will be described.

In step SB1, a node stores, in distributed ledger B10, transaction data B11 including contract code B12 in which the processing of the smart contract is written. For example, the node obtains transaction data B11 by receiving transaction data B11 from a certain information processing device through communication or by generating transaction data B11 by itself and stores obtained transaction data B11 in distributed ledger B10. Step SB1 is performed before the execution of the smart contract.

In step SB2, the node stores, in distributed ledger B10, transaction data B15 including instructions B16 to execute the smart contract. For example, the node receives transaction data B15 from a certain information processing device through communication and stores received transaction data B15 in distributed ledger B10.

In step SB3, in response to the storing of transaction data B15 including instructions B16 in distributed ledger B10 in step SB2, the node reads contract code B12 from distributed ledger B10 and executes the processing based on contract code B12. The result of the processing can be included in transaction data and stored in distributed ledger B10.

By the series of steps, upon receiving transaction data B15 including instructions B16 to execute the smart contract, the distributed ledger system executes the processing according to instructions B16 automatically (in other words, with no manual operations). Thus, it is possible to execute the processing with high efficiency (in other words, at high speed or in a short time). Achieving highly efficient processing brings about the effect of the reduction in power consumption. In addition, dispensing with manual operations makes it possible to avoid the tampering of information or misconduct by a person, or a human error before it happens. Furthermore, since the result of the processing executed in such a manner is stored in a blockchain, it is substantially impossible to tamper with the result of the processing.

FIG. 25 is an explanatory diagram illustrating the structures of an NFT and metadata. The NFT is a token stored in a distributed ledger. The NFT is a unique token (in other words, a non-fungible token). The NFT is standardized according to, but not limited to, for example, Ethereum Request for Comments (ERC) 721. The NFT may conform to a standard different from ERC 721 or may be non-standard (e.g., specific to an organization). Note that although ERC 721 is a standard about a unique token, the NFTs described in this specification need not necessarily be unique tokens.

FIG. 25 illustrates transaction data B21 stored in a distributed ledger. Transaction data B21 stores an NFT. The NFT includes a token ID (i.e., identification information with which the NFT can be uniquely identified).

The NFT includes metadata. The metadata can be arranged at a location accessible over a network (e.g., storage device B22). A token URI indicating the location of the metadata is calculated from the token ID of the NFT and a predetermined base URI.

Information managed as the NFT may be included in transaction data B21 or may be included in the metadata. The inclusion of the information managed as the NFT in the metadata produces such an advantage that the amount of information included in transaction data B21 (in other words, information included in a blockchain) can be reduced. In this case, the metadata can be considered to contain the actual conditions of the information managed as the NFT. In the case where an image is managed in the form of an NFT, a URL indicating image data on the image can be managed as the NFT.

It should be noted that each of the constituent elements in the embodiment described above may be configured in the form of an exclusive hardware product, or may be implemented by executing a software program suitable for the constituent element. Each of the constituent elements may be implemented by means of a program executor, such as a CPU and a processor, reading and executing the software program recorded on a recording medium such as a hard disk or a semiconductor memory. Here, the software program for implementing the information processing device and the related technologies according to the embodiment described above is a program described below.

That is, the program causes a computer to execute an information processing method including: obtaining first content; determining whether the first content contains first legitimacy information as a digital watermark, the first legitimacy information indicating that the first content obtained is legitimate as content to be inputted to a trained model; when the first content is determined to contain the first legitimacy information, inputting the first content to the trained model to obtain second content generated by the trained model; and outputting the second content obtained.

Hereinbefore, an information processing method and the related technologies according to one or more aspects have been described based on an exemplary embodiment, but the present disclosure is not limited to this embodiment. Various modifications of this embodiment as well as forms resulting from combinations of constituent elements in different embodiments that may be conceived by those skilled in the art may be included within the scope of one or more aspects so long as such modifications and forms do not depart from the essence of the present disclosure.

### INDUSTRIAL APPLICABILITY

The present disclosure is applicable to systems that facilitate the effective use of resources.

1. An information processing method comprising:
obtaining first content;
determining whether the first content contains first legitimacy information as a digital watermark, the first legitimacy information indicating that the first content obtained is legitimate as content to be inputted to a trained model;
when the first content is determined to contain the first legitimacy information, inputting the first content to the trained model to obtain second content generated by the trained model; and
outputting the second content obtained.

2. The information processing method according to claim 1, further comprising:
when the second content is obtained, causing second legitimacy information to be added as a digital watermark to the second content, wherein
the second legitimacy information is information indicating that the second content is legitimate content outputted by the trained model, and
in the outputting of the second content, the second content to which the second legitimacy information is added is outputted.

3. The information processing method according to claim 1, wherein
a first non-fungible token (NFT) that corresponds one-to-one to the first content is stored in a distributed ledger, the first NFT being associated with an owner of the first content as an owner of the first NFT,
the information processing method further comprising:
when the second content is obtained, storing, in the distributed ledger, a second NFT that corresponds one-to-one to the second content and is associated with an operator of an information processing system that executes the information processing method, the operator serving as an owner of the second NFT.

4. The information processing method according to claim 3, further comprising:
storing, in the distributed ledger, purchase transaction data indicating that a user is to purchase the second content and further indicating an amount of value information equivalent to a price for purchasing the second content;
storing, in the distributed ledger, first transfer transaction data indicating that a first portion of the value information is to be transferred from the user to the owner of the first content; and
storing, in the distributed ledger, second transfer transaction data indicating that a second portion of the value information excluding the first portion is to be transferred from the user to the operator.

5. The information processing method according to claim 4, wherein
the first portion accounts for a greater portion of the value information as a contribution of the first content to generation of the second content is greater, and
the second portion is a portion obtained by subtracting the first portion from an entirety of the value information.

6. The information processing method according to claim 5, wherein
the contribution of the first content to the generation of the second content is greater as a degree of similarity between the second content and the first content is greater.

7. The information processing method according to claim 1, further comprising:
when the first content is determined not to contain the first legitimacy information, prohibiting the outputting of the second content generated by the trained model.

8. The information processing method according to claim 1, wherein
the trained model is a machine learning model that has been trained using third content to generate and output fifth content based on fourth content inputted to the machine learning model, the third content being content that contains third legitimacy information as a digital watermark, the third legitimacy information indicating that the third content is legitimate as content to be inputted to the trained model, and
the fifth content is content obtained by adding, to the fourth content, a feature related to the training that the machine learning model has undergone.

9. The information processing method according to claim 1, wherein
the trained model is a neural network model.

10. An information processing method comprising:
obtaining third content;
determining whether the third content contains third legitimacy information as a digital watermark, the third legitimacy information indicating that the third content obtained is legitimate as content to be inputted to a machine learning model; and
when the third content is determined to contain the third legitimacy information, training the machine learning model to generate and output fifth content based on fourth content inputted to the machine learning model, wherein the fifth content is content obtained by adding, to the fourth content, a feature that is based on the training that the machine learning model has undergone.

11. An information processing system comprising:
an obtainer that obtains first content;
a determiner that determines whether the first content contains first legitimacy information as a digital watermark, the first legitimacy information indicating that the first content obtained is legitimate as content to be inputted to a trained model;
a controller that, when the first content is determined to contain the first legitimacy information, inputs the first content to the trained model to obtain second content generated by the trained model; and
an outputter that outputs the second content obtained.

12. An information processing system comprising:
an obtainer that obtains third content;
a determiner that determines whether the third content contains third legitimacy information as a digital watermark, the third legitimacy information indicating that the third content obtained is legitimate as content to be inputted to a machine learning model; and
a trainer that, when the third content is determined to contain the third legitimacy information, trains the machine learning model to generate and output fifth content based on fourth content inputted to the machine learning model, wherein
the fifth content is content obtained by adding, to the fourth content, a feature that is based on the training that the machine learning model has undergone.

13. A non-transitory computer-readable recording medium having recorded thereon a program for causing a computer to execute the information processing method according to claim 1.

14. A non-transitory computer-readable recording medium having recorded thereon a program for causing a computer to execute the information processing method according to claim 10.
